(19) United States
(12) Patent Application Publication
(10) Pub. No.: US 2022/0358963 A1
(43) Pub. Date: Nov. 10, 2022

(54) SEED LAYER FOR CARBON OVERCOAT IN MAGNETIC MEDIA

(71) Applicant: Seagate Technology LLC, Fremont, CA (US)

(72) Inventors: Christopher L. PLATT, Fremont, CA (US); Pin-Wei HUANG, Fremont, CA (US); Jinjun DING, Fremont, CA (US)

(21) Appl. No.: 17/308,782

(22) Filed: May 5, 2021

(51) Int. Cl. G11B 5/73; G11B 5/72

(52) U.S. Cl. CPC G11B 5/7379; G11B 5/7366; G11B 5/7264

(57) ABSTRACT

A heat-assisted magnetic recording (HAMR) media that has a substrate, a granular magnetic recording layer on the substrate, a carbon overcoat, and a non-magnetic seed layer between the granular magnetic recording layer and the carbon overcoat. The seed layer has a refractive index (n) of no more than 0.5 and an extinction coefficient (k) of at least 1, and a thickness no greater than 10 Angstrom. The seed layer can be at least one of Ag, Au, and Cu.

### BACKGROUND

Certain devices use magnetic recording media to store data. For example, disk drives are commonly found in data centers but can still also be found in desktop computers, and laptop computers.

Magnetic media store information magnetically as bits. Bits store information by holding and maintaining a magnetization. In order to store more information on a medium, bits are made smaller and packed closer together, thereby increasing the density of the bits. Therefore, as the bit density increases, disk drives can store more information. However, as bits become smaller and are packed closer together, the bits become increasingly susceptible to erasure, for example due to adjacent track interference or for thermally activated magnetization reversal (such as for heat assisted magnetic recording (HAMR)).

### SUMMARY

This disclosure provides a seed layer for a carbon overcoat layer of a magnetic media, particularly, media for heat assisted magnetic recording (HAMR). The seed layer improves the growth of carbon overcoat on granular media and has optical and thermal properties that increase thermal gradient. This allows for increased bit density and improved head-disk interface performance.

This disclosure provides, in one particular implementation, a heat-assisted magnetic recording (HAMR) media that has a substrate, a granular magnetic recording layer on the substrate, a carbon overcoat, and a non-magnetic seed layer between the granular magnetic recording layer and the carbon overcoat. The seed layer has a refractive index (n) of no more than 0.5 and an extinction coefficient (k) of at least 1, and a thickness no greater than 10 Angstrom. In some implementations, the extinction coefficient (k) is at least 5, and in other implementations, is at least 6.

This disclosure provides, in another particular implementation, a heat-assisted magnetic recording (HAMR) media that has a substrate, a granular magnetic recording layer on the substrate, a carbon overcoat, and a non-magnetic seed layer between the granular magnetic recording layer and the carbon overcoat. The seed laver comprises at least one of Ag, Au, and Cu and has a thickness no greater than 10 Angstroms.

This disclosure also provides, in a particular implementation, a heat-assisted magnetic recording (HAMR) system. The system includes a HAMR media comprising a granular magnetic recording layer, a carbon overcoat, and a non-magnetic seed layer between the granular magnetic recording layer and the carbon overcoat, the seed layer having a refractive index (n) of no more than 0.5 and an extinction coefficient (k) of at least 1, and a thickness no greater than 10 Angstrom, and a HAMR head configured to read and/or write data to the magnetic recording layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTION OF THE DRAWING

The described technology is best understood from the following Detailed Description describing various implementations read in connection with the accompanying drawing, where:

FIG. 1 is a schematic side view of an example HAMR media.

FIG. 2 is a schematic side view of a HAMR media having a seed layer.

FIG. 3 is a schematic side view of another HAMR media having a seed layer.

FIG. 4A is a schematic side view of a HAMR media and HAMR head; FIG. 4B is a schematic side view of another HAMR media and HAMR head.

### DETAILED DESCRIPTION

As indicated above, this disclosure describes a seed layer for a protective carbon overcoat for a magnetic media, such as HAMR media.

As the technology of magnetic recording media ages, it becomes increasingly difficult to continue to increase the storage capacity of recording media (e.g., disk drive disks). The predominant method to increase storage capacity is to increase the bit density on the recording media. However, increasing the bit density can decrease the signal to noise ratio (“SNR”) below acceptable levels. SNR can be increased by reducing the magnetic read/write head spacing to the recording media. Another approach is to reduce the grain or bit size of the media. However, this will lower the thermal stability of the grains within the bits, thereby increasing the grains susceptibility to fluctuation and information loss. This is a particular concern with HAMR media.

In a HAMR drive, media with a magnetically strong recording layer is heated during a magnetic writing process. The heat temporarily lowers the magnetic strength of the recording layer, allowing a write head to magnetically record information. After the information is written, the media cools and the magnetic strength returns. In the cooled, magnetically strong state, the HAMR media is highly resistant to magnetic and thermal fluctuation, thereby locking in the recorded information.

The heat, or other energy used, has a lateral thermal gradient as it passes from the source (e.g., the head) to and through the HAMR media; that is, the area affected by the heat increases. As the gradient expands, the potential for inadvertently switching adjacent bits increases.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

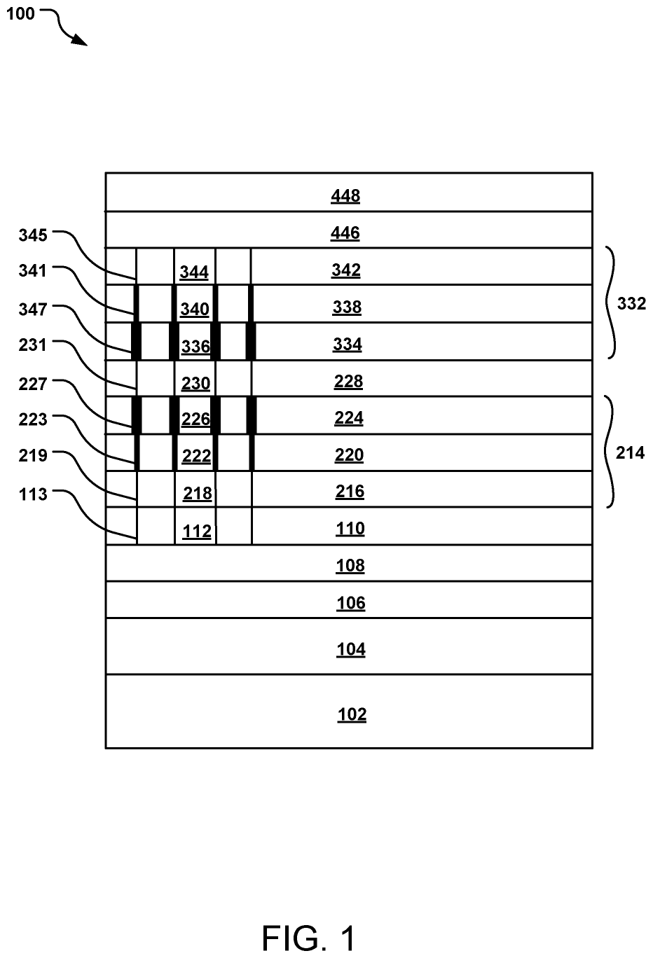

Referring now to FIG. 1, an example of a HAMR media 100 is shown. It is understood that this is one exemplary and specific implementation of a HAMR media, and that other HAMR media constructions are known. The seed layer of this disclosure can be used with and will benefit media constructions in addition to that shown in FIG. 1.

Turning to FIG. 1, a substrate 102, typically disc-shaped, provides the base for the HAMR media 100. The substrate 102 may include a non-magnetic metal, alloy, or non-metal; for example, the substrate 102 may comprise aluminum, an aluminum alloy, glass, ceramic, glass-ceramic, polymeric material, a laminate composite, or any other suitable non-magnetic material.

Overlying the substrate 102 is a continuous amorphous soft magnetic underlayer (“SUL”) 104. The SUL 104 may include one or more layers of a soft magnetic material. For example, the SUL 104 may be a 10 to 2000 Angstrom thick layer including a soft magnetic material such as Ni, NiFe, Co, CoZr, CoZrCr, CoZrNb, CoCrTaB, CoCrB, CoCrTa, CoFe, Fe, FeN, FeSiAl, FeSiAlN, FeCoC, etc. In some implementations, the SUL 104 may include multiple SUL layers, either ferromagnetically coupled or antiferromagnetically coupled. In addition, multiple SUL layers may be separated by one or more layers.

An optional wetting layer 106 (e.g., Ta wetting layer) may be present on the SUL 104 to improve adhesion of a first orientation control layer 108. The first orientation control layer 108 may have a thickness of, e.g., 5-200 Angstrom. The first orientation control layer 108 sets the crystal orientation of subsequent (upper) layers. In some implementations, the first orientation control layer 108 includes an oriented thin film of transition metal or alloy of bcc structure. The first orientation control layer 108 may include a CrX alloy, wherein X may be, for example, Mo, W, V, Hf, Fe, Ni, Nb, Ta, Zr, Mn. In some implementations, CrX may be deposited by sputtering or other techniques, at a temperature above room temperature (e.g., 100-300° C.). In some implementations, the first orientation control layer 108 may include an alloy of bcc metal with its additives, such as, MoX, WX, VX, TaX, wherein X is, for example, Cr, W, V, Hf, Fe, Ni, Nb, Ta, Zr, Mn.

Typically, the orientation of the thin film first orientation control layer 108 is the (200) orientation. However, for implementations where an hcp structured material, such as Ru is used, the orientation is (1120). It is noted that throughout this discussion although the (200) orientation is mentioned, other crystalline orientations (e.g., (1120)) may actually be present.

Overlying the first orientation control layer 108 is a second orientation control layer 110, having a thickness of, e.g., 5-200 Angstrom. Typically, the second orientation control layer 110 copies the (200) orientation of the first orientation control layer 108. In addition, the second orientation control layer 110 includes a segregant added to the material (e.g., CrX alloy) of the first orientation control layer 108 to define grains 112 and grain boundaries 113 between adjacent grains 112. For clarity of illustration, only a few of the grains 112 and grain boundaries 113 are illustrated, and it is understood that any number of grains 112 and grain boundaries 113 may be present.

The segregant may be, for example, C, B, BC, BN. Thus, as an example, the first orientation control layer 108 may include CrMo and the second orientation control layer 110 may include CrMoB. As another example, the first orientation control layer 108 may include CrMo and the second orientation control layer 110 may include CrB, where the X (e.g., Mo) is omitted. Alternately, the second orientation control layer 110 may include MoB, MoC, or another bcc metal with segregants.

The HAMR media 100 also includes a heatsink structure 214, which overlies the second orientation control layer 110. In the present design, the heatsink structure 214 includes three layers: a first portion 216, a second portion 220, and a third portion 224. However, it is understood that the heatsink structure 214 may include any number of layers.

As seen in FIG. 1, the first portion 216 of the heatsink structure 214 overlies the second orientation control layer 110. The first portion 216 may have a thickness of, e.g., 5-1000 Angstrom. The first portion 216 includes a heat conductive material that is alloyed with a segregant, which defines heat conductive grains 218 separated by grain boundaries 219 that include the segregant. As a result, the heatsink structure 214 is granular. For example, Mo (a heat conductive material) may be alloyed with other elements (segregants), such as, W, B, BN, BC, Ru, Cr, C, V, Nb, Hf, Zr, and Ti. In addition, other alloys such as W-alloys and Ru-alloys may be used, and may include, for example, B, BN, BC, Ru, W, Mo, Cr, C, V, Nb, Hf, Zr, and Ti as additives. In various implementations, the first portion 216 maintains the (200) orientation of the first orientation control layer 108 and the second orientation control layer 110.

A second portion 220 of the heatsink layer 214 overlies the first portion 216. The second portion 220 may have a thickness of, e.g., 5-500 Angstrom. The second portion 220 is also granular having grains 222 and grain boundaries 223. The second portion 220 includes more of the segregant than the first portion 216 and as such, the grain boundaries 223 are thicker than the grain boundaries 219 in the first portion 216. In various implementations, the grain boundaries 223 in the second portion 220 include a greater amount of material than the grain boundaries 219 in the first portion 216. The segregant in the second portion 220 may be the same material or a different material than the segregant in the first portion 216. The second portion 220 maintains the (200) or other orientation.

A third portion 224 of the heatsink layer 214 overlies the second portion 220. The third portion 224 may have a thickness of, e.g., 5-500 Angstrom, and is also granular having grains 226 and grain boundaries 227. The third portion 224 includes more of the segregant than the first portion 216 and the second portion 220. As such, grain boundaries 227 in the third portion 224 are thicker than the grain boundaries 219 in the first portion 216 and the grain boundaries 223 in the second portion 220. In general, the grain boundaries 227 in the third portion 224 include a greater amount of material than the grain boundaries 219 in the first portion 216 and the grain boundaries 223 in the second portion 220. In some implementations, the segregant in the third portion 224 may be the same material or a different material than the segregant in the first portion 216 and/or the segregant in the second portion 220, The third portion 224 maintains the (200) or other orientation.

The gradient of segregant enhances granularity in the heatsink structure 214. The amount of the segregant (e.g., mole percentage) increases in overlying layers, as described above. For example, the amount of segregant increases from the first portion 216 to the second portion 220 and again to the third portion 224. Therefore, the mole percentage could increase from, e.g., 5% to 10% to 15%.

In different implementations, the heat conductive material in the first portion 216, the second portion 220, and the third portion 224 may be the same or different, and/or the segregant material in the first portion 216, the second portion 220, and the third portion 224 may be the same or different. Furthermore, different implementations may include more layers with varying amounts of heat conductive material and segregant material in the heatsink structure 214.

In an alternate implementation, the heatsink structure 214 is positioned between the substrate 102 and the SUL layer 104. In another alternate implementation, the heatsink structure 214 may be present as two separate structures, with the SUL layer 104 present between the two heatsink structures. In such a configuration, each of the heatsink structures may have the same number of layers, e.g., three layers (e.g., a first portion, a second portion, and a third portion), or may have a different numbers of layers.

A thermal resistor layer 228 overlies the heatsink structure 214, and may be deposited, for example, by sputtering or other techniques. The thermal resistor layer 228 may have a thickness of, e.g., 5-100 Angstrom. In various implementations, the thermal resistor layer 228 is granular and maintains the previous crystal orientation. The thermal resistor layer 228 resists heat and may be used to control the transfer of heat (e.g., lateral transfer of heat) through the HAMR media 100. As such, the thermal resistor layer 228 includes heat resistive grains 230 separated by grain boundaries 231. When the thermal resistor layer 228 is deposited over the heatsink structure 214, the grain boundaries 231 of the thermal resistor layer 228 align over the grain boundaries (e.g., grain boundary 227) of the heatsink structure 214. As a result, the granularity is maintained from the heatsink structure 214 to the thermal resistor layer 228. Heat may be applied before or after deposition of the thermal resistor layer 228 to promote and ensure ample diffusion of the segregant from the third portion 224 into the grain boundaries 230. The thickness of grain boundaries 231 as illustrated is merely exemplary and is not limiting. Indeed, the thickness of grain boundaries 231 may be smaller than, the same as, or larger than the thickness of underlying grain boundaries 227 in the third portion 224 of the heatsink structure 214. It is noted that the thermal resistor layer 228 may include more than one layer (e.g. 2, 3, 4, or more sublayers).

Present over the thermal resistor layer 228 is a magnetic recording layer 332. In the shown design, the recording layer 332 includes three layers: a first portion 334, a second portion 338, and a third portion 342; however, it is understood that the recording layer 332 may include any number of layers.

The first portion 334 of the recording layer 332 may have a thickness of, e.g., 5-100 Angstrom. The first portion 334 includes a magnetic material that is alloyed with a segregant to form a granular portion having grains 336 and grain boundaries 337. For example, FePtX (a magnetic material) may be alloyed with other elements, such as, carbon (a segregant), The X represents elements such as Cu, Ag, Co, Au, Ir, Re, Rh, Pd, Ni, or combinations of the foregoing. In various implementations, the first portion 334 changes the crystal orientation to (002) from the (200) orientation of the underlying thermal resistor layer 228.

The second portion 338 of the recording layer 332 overlies the first portion 334 and may have a thickness of, e.g., 5-100 Angstrom. The second portion 338 is granular having grains 340 separated by grain boundaries 341. The second portion 338 includes less of the segregant than the first portion 334. As such, the grain boundaries 341 in the second portion 338 are thinner than the grain boundaries 337 in the first portion 334. In various implementations, the second portion 338 maintains the (002) or other orientation.

The third portion 342 of the recording layer 332 overlies the second portion 338 and may have a thickness of e.g., 5-100 Angstrom. The third portion 342 is granular having grains 344 separated by grain boundaries 345. The third portion 342 includes less of the segregant than the first portion 334 and the second portion 338. As such, the grain boundaries 345 in the third portion 342 are thinner than the grain boundaries 337 in the first portion 334 and the grain boundaries 341 in the second portion 338. In various embodiments, the third portion 342 maintains the (002) or other orientation.

As such, a gradient of segregant is utilized to achieve smoothness (e.g., a physically smooth surface) of the recording layer 332. A smooth surface allows the drive head to fly closer, wherein a rough surface would cause the drive head to crash at an equivalent fly height. In order to achieve a smooth surface, the amount of the segregant (e.g., volume, or mole percentage) decreases in overlying layers. For example, the amount of segregant decreases from the first portion 334 to the second portion 338. The amount of segregant decreases again from the second portion 338 to the third portion 342. Therefore, the mole percentage could decrease from, e.g., 15% to 10% to 5%.

In different implementations, the magnetic material in the first portion 334, the second portion 338, and the third portion 342 may be the same or different, and/or the segregant material in the first portion 334, the second portion 338, and the third portion 342 may be the same or different. Furthermore, different implementations may include more or fewer layers with varying amounts of magnetic material and segregant material in the recording layer 332.

In addition, in further implementations, the smoothness of the recording layer 332 may be controlled by other methods or designs. In such implementations, the first portion 334, the second portion 338, and the third portion 342 may include the same amount of segregant or increasing amounts of segregant. One methodology is to include a layer 446 overlying the recording layer 332; this layer 446 is optional in the HAMR media 100.

In one implementation, the layer 446 is a magnetic sealer layer deposited, for example, by sputtering or other techniques over and directly in contact with the recording layer 332. The magnetic sealer layer may have a thickness of, e.g., 5-50 Angstrom. The magnetic sealer layer further reduces surface roughness of the recording layer 332, ensuring that a small head to media spacing (“HMS”) can be maintained. The magnetic sealer layer may include, for example, Pt, PtC, FePtC, etc. In various embodiments, the amount of carbon may vary from 0-20%.

In another implementation, the layer 446 is a capping layer or cap layer, which improves SNR by providing a decrease in the magnetic switching field needed to flip the bits in the adjacent recording layer 332. The capping layer may have a thickness of e.g., less than 2 nm, e.g., 0.3-1.5 nm. The capping layer may include, for example, Co, Ni, Fe, Pt, and can include additives including rare earth elements, and/or amorphizing agents such as B, Zr, Ta, Cr, V, and Mo. One particular capping layer includes CoCrPtB. In some implementations, the capping layer can be deposited (e.g., sputtered) on the recording layer 332, whereas in other implementations, the capping layer can be implanted in the top surface of the recording layer 332, e.g., using ion implantation. Examples of ionized species that can be implanted to form the capping layer include Ni, Co, Fe, Cr, Ta, C, N, B, P, F, Si, and Ge.

Returning to FIG. 1, the HAMR media 100 includes an overcoat layer 448 (e.g., a carbon overcoat layer) over the layer 446 and the recording layer 332. The overcoat layer 448 may include materials such as, for example, amorphous diamond-like carbon (DLC). In some implementations, the overcoat layer 448 is hydrogenated or nitrogenated carbon.

Summarized, the HAMR media 100 of FIG. 1 is one specific and exemplary configuration of a HAMR media. The discussion below provides a seed layer for the overcoat layer 448, e.g., between the recording layer 332 and the overcoat layer 448, or between the layer 446 (if present) and the overcoat layer 448.

As indicated above, the HAMR media 100 of FIG. 1 is one specific and exemplary configuration of a HAMR media into which a seed layer for the carbon overcoat can be added. Other HAMR media in which a seed layer for the carbon overcoat can be incorporated may or may not have, e.g., a gradient of segregant, multiple layers of a heatsink structure, a soft under layer (SUL), a wetting layer, any other seed layers (e.g., a seed layer for the SUL).

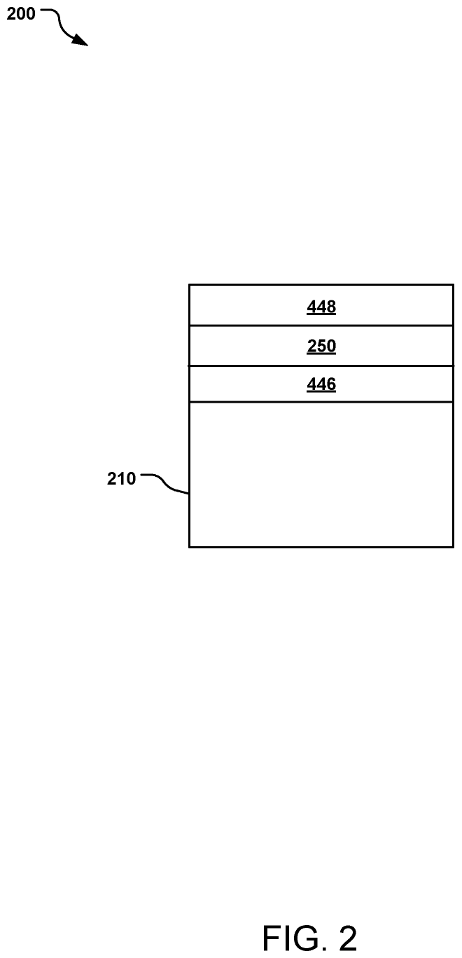

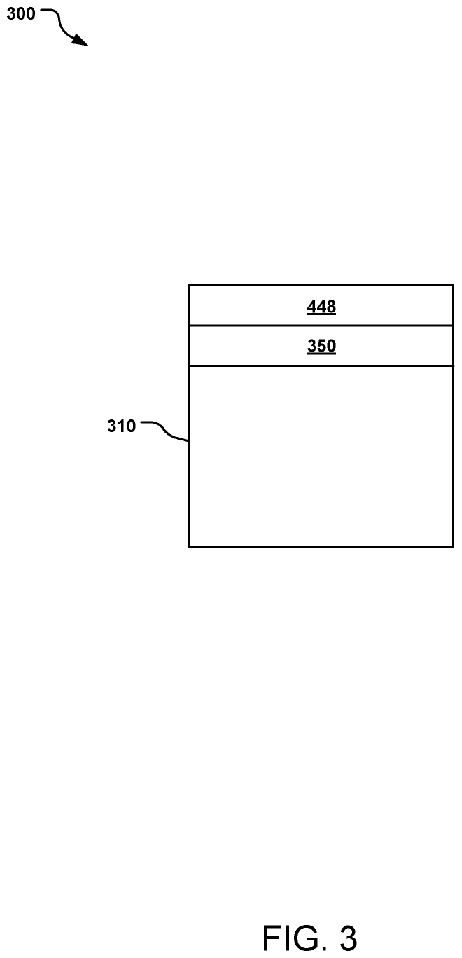

FIGS. 2 and 3 show a HAMR media including a seed layer for the overcoat layer.

In FIG. 2, a HAMR media 200 has a media base 210, which includes various structures and layers including at least a substrate (e.g., substrate 102) and a recording layer (e.g., recording layer 332). This media 200 also includes a layer 446 to increase the smoothness of the recording layer and/or decrease the switching field for the recording layer. Present on and in contact with the layer 446 is a seed layer 220 and an overcoat layer 448.

In FIG. 3, a HAMR media 300 has a media base 310, which includes various structures and layers including at least a substrate (e.g., substrate 102) and a recording layer (e.g., recording layer 332). Present on and in contact with the media base 310 is a seed layer 320 and an overcoat layer 448.

In both implementations, the seed layer 220, 320 is a thin, nonmagnetic layer having low thermal conductivity that provides a uniform surface on which the overcoat layer 448 is formed (e.g., grown, or deposited). The seed layer 220, 320 may provide some corrosion protection to the recording layer and also mechanical properties that contribute to the overall mechanical performance of the overcoat. The seed layer is thin, having a thickness no more than 1 nm (no more than 10 Angstrom), in some implementations, the seed layer has a thickness no more than 5 Angstrom. The combined seed layer and overcoat layer thickness, which is about 25 Angstrom in some implementations, can be managed to control the HMS.

The material of the seed layer can be selected so that the combined seed layer and overcoat layer has optical properties (refractive index, “n,” and extinction coefficient, “k”) that increase absorption of the energy (e.g., thermal energy) delivered from the HAM head to the HAMR media while having low thermal conductivity to increase the thermal gradient through the seed layer and the overcoat layer. In some implementations, the “n” of the seed layer is no more than 0.5 and “k” is at least 1, in some implementations, at least 5 or at least 6.

Examples of materials for the seed layer include C. N, Si, Group IB metals (e.g., Cu, Ag, Au), Group VB metals (e.g., Nb), and alloys thereof. As indicated above, the seed layer is non-magnetic and is generally free of materials such as Fe, Ni, Cr, Co. The material of the seed layer is selected to inhibit and, in some implementations, prevent lateral thermal diffusion. In some implementations, in-plane thermal conductivity of the carbon overcoat and the seed layer is less than 15 W/(mK).

The seed layer may be deposited on the media or any capping or other layer by sputtering or other techniques, at room temperature or above room temperature. Chemical vapor deposition (CVD), including plasma enhanced CVD (PECVD), and RF sputtering are suitable methods for forming the seed layer. Any suitable CVD, PECVD or other deposition apparatus that can form the desired seed layer may be used under conventional operational parameters.

Due to the thickness of the seed layer and the granular nature of the magnetic recording layer, the material of the seed layer may not be continuous, but rather, the seed layer may have discontinuities. It is however, smooth, devoid of noticeable bumps, crags, etc.

Because of the optical properties and low thermal conductivity of the seed layer, the resulting HAMR media has an improved thermal gradient with a narrower lateral spread of heat, which results in increased data density.

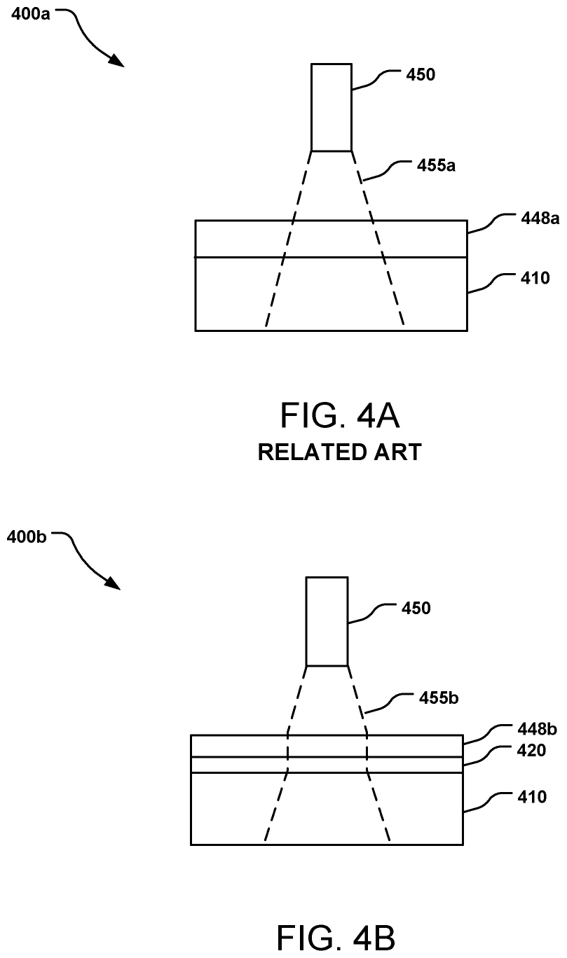

FIG. 4A and FIG. 4B contrast the effect of including a seed layer for the carbon overcoat layer. FIG. 4A shows a conventional system 400a where the HAMR media has a carbon overcoat layer directly on the recording layer (optionally with a capping layer or the like) and FIG. 4B shows a system 400b where the HAMR media has a seed layer between the carbon overcoat and the recording layer (optionally with a capping layer or the like).

In the system 400a, a HAMR media is shown having a media base 410, which includes various structures and layers including at least a substrate (e.g., substrate 102) and a recording layer (e.g., recording layer 332), and optionally a capping layer, magnetic sealing layer, or the like. Present on and in contact with the media base 410 is an overcoat layer 448a. In the system 400b, a HAMR media is shown having a media base 410, which is the same as in the system 400a. Present on and in contact with the media base 410 is a seed layer 420 and the same overcoat layer 448b. The two overcoat layers are identified differently, as layer 448a in FIG. 4A and as layer 448h in FIG. 4B.

Both of the systems 400a, 400b have a HAMR head 450, which can also be referred to as a near field transistor (NFT). The head 450 emits energy (e.g., heat) toward and into the HAMR media, which facilitates switching of the bits in the media. As seen in the system 400a of FIG. 4A, the overcoat layer 448a allows the energy from the head 450 to diffuse into the base media 410 unaffected, at an unaltered thermal gradient 455a. This is due to the overcoat layer 448a having no optical absorption properties, thus not affecting the diffusion of the thermal gradient 455a from the head 450.

However, in the system 400b of FIG. 4B, the seed layer 420 modifies the overcoat layer 448b, so that the resulting overcoat layer 448b and seed layer 420, together, disrupt the diffusion of the energy from the head 450, reducing the width of the thermal gradient 455b into the base media 410.

The seed layer 420 is selected to provide desired optical properties to itself and to the overcoat layer 448b grown thereon, resulting in a combined structure (seed plus overcoat) that absorbs thermal energy and inhibits diffusion, thus effectively narrowing the thermal gradient. Thus, by including the seed layer 420, the HMS penalty to thermal gradient is effectively reduced since the seed and overcoat combination reduces thermal spread, as seen by the non-constantly diverging thermal gradient shows in FIG. 4B. Comparing the thermal gradients 455a, 455b of the two systems 400a, 400b, respectively, it is readily discernable that the thermal spread is less for the system 400h with the seed layer 420. Also, in FIG. 4B and the system 400b, the HMS is measured from the head 450 to the top surface of the overcoat layer 448b, whereas in the system 400a of FIG. 4A, the HMS is measured from the head 450 to the base layer 410, below the overcoat layer 448a. However, the physical spacing HMS penalty remains for the magnetic recording signal SNR for both systems.

In summary, described herein is a seed layer for a carbon overcoat in a magnetic media, such as HAMR media. The seed layer is non-magnetic, has low thermal conductivity, and has particular optical properties.

The above specification and examples provide a complete description of the structure and use of exempla), implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Certain spatially related terms such as “over,” “overlying,” “above,” “under,” etc. are understood to refer to elements that may be in direct contact or may have other elements in-between, unless specifically stated in one manner or the other. For example, two layers may be in overlying contact, wherein one layer is over another layer and the two layers physically contact. In another example, two layers may be separated by one or more layers, wherein a first layer is over a second layer and one or more intermediate layers are between the first and second layers, such that the first and second layers do not physically contact.

Since many implementations of the invention can be made without departing from the spirit and scope of the invention, the invention resides in the claims hereinafter appended. Furthermore, structural features of the different implementations may be combined in yet another implementation without departing from the disclosure or the recited claims.

1. A heat-assisted magnetic recording (HAMR) media comprising:
a substrate,
a granular magnetic recording layer on the substrate,
a carbon overcoat, and
a non-magnetic seed layer having a thickness no greater than 5 Angstrom between the granular magnetic recording layer and the carbon overcoat, the seed layer having a refractive index (n) of no more than 0.5 and an extinction coefficient (k) of at least 1, and a thickness no greater than 10 Angstrom.

2. The media of claim 1, wherein the extinction coefficient (k) is at least 5.

3. The media of claim 2, wherein the extinction coefficient (k) is at least 6.

4. The media of claim 1, wherein the seed layer comprises at least one of Ag, Au, and Cu.

5. The media of claim 1, wherein the magnetic recording layer includes a capping layer.

6. The media of claim 1, wherein the seed layer and the overcoat layer combined have a thickness of less than 25 Angstrom.

7. A heat-assisted magnetic recording (HAMR) media comprising:
a substrate,
a granular magnetic recording layer on the substrate,
a carbon overcoat, and
a non-magnetic seed layer having a thickness no greater than 5 Angstrom between the granular magnetic recording layer and the carbon overcoat, the seed layer comprising at least one of Ag, Au, and Cu and having a thickness no greater than 10 Angstroms.

8. The media of claim 7, wherein the seed layer has a refractive index (n) of no more than 0.5 and an extinction coefficient (k) of at least 1.

9. The media of claim 8, wherein the extinction coefficient (k) is at least 5.

10. The media of claim 9, wherein the extinction coefficient (k) is at least 6.

11. The media of claim 7, wherein the magnetic recording layer includes a capping layer.

12. The media of claim 7, wherein the seed layer and the overcoat layer combined have a thickness of less than 25 Angstrom.

13. A heat-assisted magnetic recording (HAMR) system comprising:
a HAMR media comprising a granular magnetic recording layer, a carbon overcoat, and a non-magnetic seed layer having a thickness no greater than 5 Angstrom between the granular magnetic recording layer and the carbon overcoat, the seed layer having a refractive index (n) of no more than 0.5 and an extinction coefficient (k) of at least 1, and a thickness no greater than 10 Angstrom; and
a HAMR head configured to read and/or write data to the magnetic recording layer.

14. (canceled)

15. The HAMR system of claim 13, wherein the magnetic recording layer includes a capping layer.

16. (canceled)

17. The HAMR system of claim 13, wherein the seed layer is discontinuous.

18. (canceled)

19. The media of claim 1, wherein the seed layer is discontinuous.

20. (canceled)

21. The media of claim 7, wherein the seed layer is discontinuous.
